(19) United States
(12) Patent Application Publication
(10) Pub. No.: US 2013/0057823 A1
(43) Pub. Date: Mar. 7, 2013

(54) EYEGLASSES HOLDER

(71) Applicant: Darren J. Cluff, Highland, UT (US)

(72) Inventor: Darren J. Cluff, Highland, UT (US)

(21) Appl. No.: 13/227,269

(22) Filed: Sep. 7, 2011

(51) Int. Cl. G02C 3/00

(52) U.S. Cl. 351/155

(57) ABSTRACT

An eyeglasses holder, including also corrective lenses, sunglasses or the like. The eyeglasses holder is a tubular oval-shaped cylinder with flexible caps attached on either end for the eyeglasses to be securely placed with one arm of the glasses passing through the tube secured by the flexible caps. The caps are made of a flexible material allowing the eyeglasses arm to pass through the middle section of each cap, gripping and holding the eyeglasses in place. In use, one earpiece of a pair of eyeglasses is taken and placed through the flexible material of one cap and pushed through the tube and out the flexible material of the other cap. Dual-sided Velcro-type fasteners are-used to adhere the eyeglasses holder to the desired item.

### BACKGROUND OF THE INVENTION

This invention relates to a support and holder for eyeglasses which can be attached to any type of vehicle, bicycle, furniture or wall.

While prior art includes many variations of an eyeglasses holder, none are believed to contemplate or suggest the present invention.

Eyeglass supports and holders are in common use. There are no such carriers which secure the eyeglasses in a reliable manner.

During the search the following patents were deemed at least generally pertinent to the present invention:

| U.S. Patent No. | Date | Inventor | Class/Subclass |
|---|---|---|---|
| 6,206,258 | Mar. 27, 2001 | Calder | 224/420 |
| 2,884,220 | Apr. 28, 1959 | Manley | 248/309 |
| D 423,777 | May 02, 2000 | Folisi | D3/266 |
| D471,709 S | Mar. 18, 2003 | Coyne | D3/266 |
| 6,039,173 | Mar. 21, 2000 | Crow | 206/5 |
| D619,360 | Jul. 13, 2010 | Ledford | D3/265 |
| D292,595 | Nov. 03, 1987 | Tanaka | D16/129 |

Unlike any present invention, the prior art fails to contemplate an eyeglass holder which can secure at two separate points a length of the eyeglasses arm while providing a gripping area at each point to more reliably secure the eyeglasses.

### BRIEF SUMMARY OF THE INVENTION

The eyeglasses holder is a tubular oval-shaped cylinder with flexible caps attached on either end for the spectacles to be securely placed with one arm of the glasses passing through the tube and being held securely with the material of the flexible top and bottom.

The top and bottom caps are made of a flexible material that will allow the eyeglasses arm to pass through the middle section of the cap. The flexible material will grip and hold the eyeglasses in place.

An object of the present invention is to securely hold eyeglasses even under rough and bumpy conditions.

Another object of the present invention is to provide a relatively small, modern and attractive eyeglass holder which is visually pleasing.

Another object of the present invention is to provide a simple to use eyeglass holder.

Another object of the present invention is to provide an eyeglasses holder which can be attached to a variety of different surfaces and by several different means (adhesive, Velcro, or zip ties as an example).

Another object of the present invention is for the eyeglasses holder to remain readily accessible.

Another object of the present invention is to provide an eyeglasses holder that can hold a wide variety of eyeglasses, sunglasses, in various sizes and shapes.

Other aspects and many of the attendant advantages will be more readily understood by reference to the following detailed description with reference to the accompanying drawing.

The features of the present invention which are believed to be novel are set forth with particularity in the appended claim.

Drawings (See separately attached drawing)

### BRIEF DESCRIPTION OF THE DRAWINGS

FIG. 1 is a perspective drawing of the tube which holds the caps on either end of the tube in place.

FIG. 2 is a perspective drawing of the cap on either end of the tube.

FIG. 3 is a perspective drawing of the eyeglasses holder according to the present invention.

FIG. 4 is a perspective drawing of the Velcro-type fastener attached to the eyeglasses holder.

FIG. 5 is a perspective drawing of the eyeglasses holder securing a pair of eyeglasses.

### DETAILED DESCRIPTION OF THE DRAWINGS

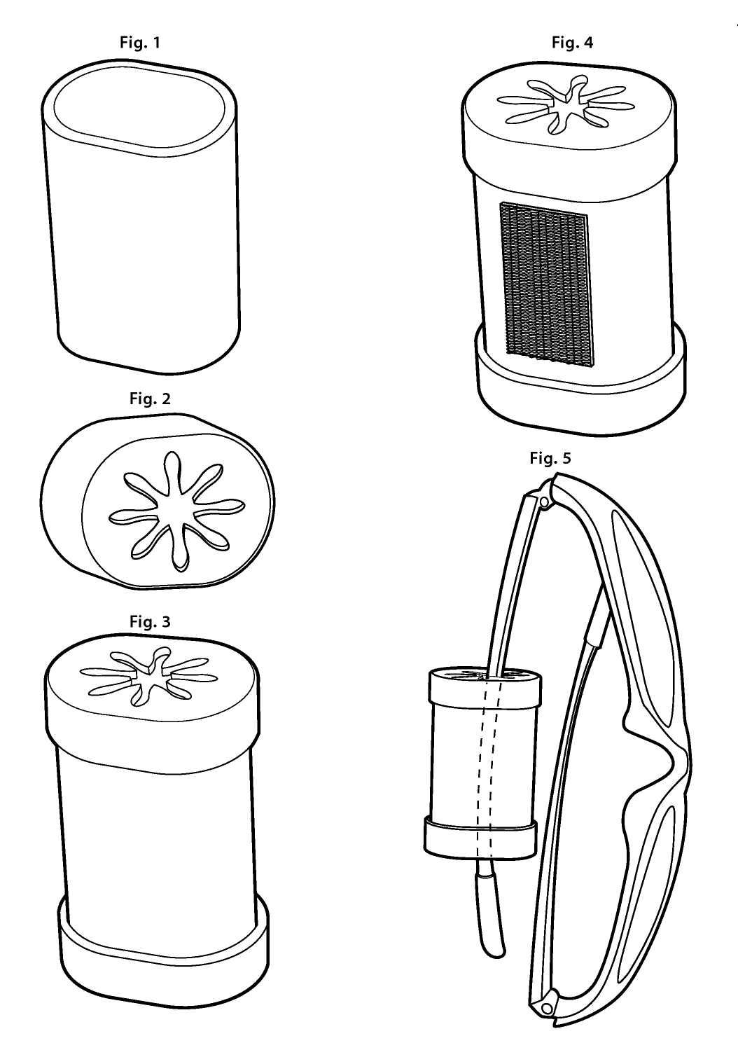

Referring to FIG. 1, in conjunction with FIG. 2 and FIG. 3 and FIG. 5, the eyeglasses holder is a tubular oval-shaped cylinder (FIG. 1) with flexible caps (FIG. 2) attached on either end for the eyeglasses to be securely placed with one arm of the glasses passing through the tube and being held securely in place by the caps (FIG. 5).

The top and bottom caps (FIG. 2) are made of a flexible material with a series of slits in the material extending from the center point outward toward the outer wall of the cap that will allow the eyeglasses arm to pass through the middle section of the cap. The flexible material will grip and hold the eyeglasses in place (FIG. 5).

The invention embodiments herein described are done so in detail for exemplary purposes only, and may be subject to many different variations in design, structure, application and operation methodology. Thus, the detailed disclosures herein should be interpreted in an illustrative, exemplary manner, and not in a limited sense.

### Operation

One earpiece of a pair of eyeglasses is taken and placed through the flexible material of one cap and pushed through the tube and out the flexible material of the other cap. The eyeglasses arm is then held securely in two separate points by the flexible material of the caps on either end of the tube.

### Description—Additional

One side of velcro-type fastener is attached to the flat side of the tube and the other side of the Velcro-type fastener is placed on the item to which the eyeglasses holder is desired to be attached.

### Operation—Additional

One side of the Velcro-type fastener is attached to an item to which the eyeglass holder is desired to be attached, the other side of the Velcro-type fastener is attached to the eyeglass holder tube, and the two are fastened together with the Velcro-type fastening system.

What is claimed is:

1. The method of holding eyeglasses, comprising:
a. a tubular oval-shaped cylinder; and
b. caps attached on either end of the tube made of a flexible material that will allow the eyeglasses arm to pass through the middle section of the caps and grip and hold the eyeglasses in securely place.

2. The method of claim 1, wherein one side of the Velcro-type fastener is attached to an item to which the eyeglass holder is desired to be attached, the other side of the Velcro-type fastener is attached to the eyeglass holder tube, and the two are fastened together with the Velcro-type fastening system.
